(19) United States
(12) Patent Application Publication
(10) Pub. No.: US 2013/0159587 A1
(43) Pub. Date: Jun. 20, 2013

(54) Interconnect Redundancy for Multi-Interconnect Device

(71) Applicants: Aaron Nygren, Truckee, CA (US); Anwar Kashem, Cambridge, MA (US); Bryan Black, Spicewood, TX (US); James Michael O'Connor, Austin, TX (US); Warren F. Kruger, Sunnyvale, CA (US)

(72) Inventors: Aaron Nygren, Truckee, CA (US); Anwar Kashem, Cambridge, MA (US); Bryan Black, Spicewood, TX (US); James Michael O'Connor, Austin, TX (US); Warren F. Kruger, Sunnyvale, CA (US)

(21) Appl. No.: 13/326,663

(22) Filed: Dec. 15, 2011

(51) Int. Cl. G06F 13/36

(52) U.S. Cl. 710/306

(57) ABSTRACT

A multi-interconnect integrated circuit device includes an input/output (I/O) circuit for conveying a plurality of interleaved data channel groups by configuring the I/O circuit to convey a first data channel group over a default fixed interconnect signal paths if there are no connection failures in the default fixed interconnect signal paths, and to convey the first data channel group over a second plurality of default fixed interconnect signal paths if there is at least one connection failure in the first plurality of default fixed interconnect signal paths, where the second plurality of default fixed interconnect signal paths includes a redundant fixed interconnect signal path for replacing a failed interconnect signal path from the first plurality of default fixed interconnect signal paths.

### BACKGROUND OF THE INVENTION

1. Field of the Invention

The present invention relates in general to integrated circuits. In one aspect, the present invention relates to the repair of input/output and signal connections in integrated circuit devices.

2. Description of the Related Art

With today's high performance integrated circuit devices, millions of components (e.g., transistors, interconnects, pads, etc.) are integrated into one or more die to provide smaller and more powerful semiconductor packages. With ongoing demand to improve chip performance by increasing the component density, individual packaged devices include not only additional transistor counts, but also more power supply and input/output (I/O) pins. For example, stacked semiconductor devices are proposed to achieve increased device density by connecting multiple die together in a single package, resulting in even larger input/output (I/O) connection counts. However, with increased density comes higher failure rates due to challenges associated with forming I/O conductors through multiple interconnect metal and packaging substrate layers, especially where the fabrication technology is immature.

Accordingly, a need exists for an improved integrated circuit device and method for manufacturing same which addresses various problems in the art that have been discovered by the above-named inventor where various limitations and disadvantages of conventional solutions and technologies will become apparent to one of skill in the art after reviewing the remainder of the present application with reference to the drawings and detailed description which follow, though it should be understood that this description of the related art section is not intended to serve as an admission that the described subject matter is prior art.

### SUMMARY OF EMBODIMENTS THE INVENTION

Broadly speaking, the present invention provides an integrated circuit device, architecture, system, method of operation and method of manufacture wherein one or more replacement I/O interconnect paths are provided in an integrated circuit device having a plurality of default I/O interconnect paths so that the replacement I/O interconnect path(s) may be used as replacement channels should there be any failures in a channel associated with the default I/O interconnect paths. In this context, a channel refers to an I/O conductor path that may include one or more microbumps, through-silicon vias, bumps, solder balls, and/or other conductors connected to provide a voltage or signal path. In addition, a failure refers to an open-circuit (e.g., a microbump that does not electrically contact a connector in the interposer), a short-circuit (e.g., two or more separate channels connected together), an interconnect path with partial connectivity leading to high resistivity, or any functional defect in an interconnect path, such as defects resulting in frequency loss of data. To provide a replacement path which avoids or bypasses a failed I/O interconnect path, the replacement I/O interconnect path(s) are allocated with the default I/O interconnect paths using an interleaved placement to define physical and logical channels to improve failure coverage. In selected embodiments, a replacement I/O interconnect path is assigned to a plurality of default I/O interconnect paths in a first group of I/O interconnect paths which is interleaved with a second group of I/O interconnect paths. Within each group, a repair is performed by shifting the data away from the failed I/O interconnect path to the immediate neighbor I/O interconnect path. In addition, a method for controlling channel repair is provided wherein both devices sharing a defective channel/path are programmed to use a replacement I/O interconnect path to replace the defective channel/path.

In selected example embodiments, a multi-interconnect integrated circuit device and method of operation are disclosed whereby an input/output (I/O) circuit is used to convey one or more data channel groups over a plurality of fixed interconnect signal paths. The multi-interconnect integrated circuit may be implemented as a system on a chip (SoC), a system in package (SIP), a multichip package (MCP), a package-on-package (PoP), or a multichip module (MCM), such as a memory controller circuit and stacked memory device. As disclosed, the I/O circuit operable to convey the data channel group(s) between first and second integrated circuit die, and may be configured operate in at least a first mode (if there are no connection failures in a first plurality of default interconnect signal paths) and a second mode (if there is at least one connection failure in the first plurality of default interconnect signal paths). In selected embodiments, each fixed interconnect signal path is formed from one or more patterned conductor lines, microbumps, or through-silicon via conductors for conveying a data channel signal. In a first operational mode, the I/O circuit may be configured to convey a first data channel group over a plurality of default fixed interconnect signal paths if there are no connection failures in the default fixed interconnect signal paths. In a second operational mode, the I/O circuit may be configured to convey the first data channel group over a second plurality of fixed interconnect signal paths if there is at least one connection failure in the default fixed interconnect signal paths, where the second plurality of fixed interconnect signal paths includes a redundant fixed interconnect signal path for replacing a failed interconnect signal path from the default fixed interconnect signal paths. To detect connection failures, the I/O circuit may include test circuitry for detecting any connection failure in the default fixed interconnect signal paths. The disclosed redundant fixed interconnect signal path may be separate from the default fixed interconnect signal paths and not connected to convey a data channel if there are no connection failures in the default fixed interconnect signal paths. Alternatively, the redundant fixed interconnect signal path may be one of the default fixed interconnect signal paths (e.g., (e.g., error correction code (ECC) that is repurposed as the redundant fixed interconnect signal path if there is at least one connection failure in the default fixed interconnect signal paths. In selected embodiments, the I/O circuit includes a plurality of input and output multiplexers which are configured to convey the first data channel group as input/output data over the default fixed interconnect signal paths in response to one or more selection control signals indicating that there are no connection failures in the default fixed interconnect signal paths. The plurality of input and output multiplexers may also be configured to convey the first data Channel group as input/output data over the second plurality of fixed interconnect signal paths in response to one or more selection control signals indicating that there is at least one connection failure in the default fixed interconnect signal paths. With the disclosed I/O circuit, first and second interleaved data channel groups may be assigned to the fixed interconnect signal paths in the first and second plurality of fixed interconnect signal paths so that channels from the first and second interleaved data channel groups alternate in a row of fixed interconnect signal paths.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates alike or similar element.

FIG. 1 illustrates a cross-sectional view showing an example integrated circuit device with a processor unit and a stacked memory.

FIGS. 2(a)-(b) illustrate the operation of a redundancy multiplexer circuit in accordance with selected embodiments of the present invention.

FIG. 3 illustrates first allocation of data channels and replacement channels in accordance with selected embodiments of the present invention.

FIG. 4 illustrates four groups of physically interleaved data channels and replacement channels in accordance with selected embodiments of the present invention,

FIG. 5 illustrates the allocation of two groups of data channels from FIG. 4 in the case when there are no failed data channels in the two groups.

FIG. 6 illustrates the allocation of two groups of data channels from FIG. 4 after the data channels are shifted away from two non-adjacent failed data channels to use the replacement channels in accordance with selected embodiments of the present invention.

FIG. 7 illustrates the allocation of two groups of data channels from FIG. 4 after the data channels are shifted away from two vertically-adjacent failed data channels to use the replacement channels in accordance with selected embodiments of the present invention.

FIG. 8 illustrates the allocation of two groups of data channels from FIG. 4 after the data channels are shifted away from two horizontally-adjacent failed data channels to use the replacement channels in accordance with selected embodiments of the present invention.

FIG. 9 illustrates four groups of physically interleaved data channels and ECC channels in accordance with selected embodiments of the present invention.

FIG. 10 illustrates the allocation of two groups of data channels from FIG. 9 in the case when there are no failed data channels in the two groups.

FIG. 11 illustrates the allocation of two groups of data channels from FIG. 9 after the data channels are shifted away from two non-adjacent failed data channels to use the ECC channels as replacement channels in accordance with selected embodiments of the present invention.

FIG. 12 illustrates the allocation of two groups of data channels from FIG. 9 after the data channels are shifted away from two vertically-adjacent failed data channels to use the ECC channels as replacement channels in accordance with selected embodiments of the present invention.

FIG. 13 illustrates the allocation of two groups of data channels from FIG. 9 after the data channels are shifted away from two horizontally-adjacent failed data channels to use the ECC channels as replacement channels in accordance with selected embodiments of the present invention.

FIG. 14 depicts an exemplary flow methodology for providing interconnect redundancy.

### DETAILED DESCRIPTION OF EMBODIMENTS

A integrated circuit package and associated method of fabrication and operation are described wherein one or more integrated circuit die are provided with multiple data channels that are routed across bidirectional input/output (I/O) interconnect paths, as well as to unidirectional channels (e.g., pinput or output) interconnect paths, including one or more extra or redundant I/O interconnect paths that can be used as replacement I/O interconnect paths if any of the regular channel interconnect paths fail. In packaging solutions with multiple die (e.g., a processor die with stacked DRAM connected across an electrical interface routing of conductor lines and microbump conductors) having a large (e.g., 6k) number of connection channels, redundant I/O interconnect paths can be used in place of default I/O interconnect paths that fail for any reason, such as a short between neighboring microbumps or a failure to make electrical contact with a microbump. By switching one or more redundant I/O interconnect paths as replacement I/O interconnect paths using a fixed or programmable multiplexer circuit, interconnect failures in the integrated circuit package can be repaired. In addition, adjacent channel failures can be repaired by using an interleaved physical and logical placement of the I/O interconnect paths to provide redundant I/O interconnect paths. In selected embodiments, first and second I/O connection channel groups are interleaved together, where each I/O connection channel group includes at least one redundant I/O interconnect path and a plurality of regular or mission-mode I/O interconnect paths such that data is steered to a redundant path if a regular or mission-mode path fails. In other embodiments, the interleaved I/O connection channel groups each include one or more non-data interconnect paths (e.g., error correction code (ECC) interconnect paths) that are used as a redundant I/O interconnect path(s) if a mission-mode path fails. Thus, instead of including extra redundant I/O interconnect paths, the ECC interconnect path is used as a replacement path. To facilitate path repair, a redundancy control mechanism allows both sides of a defective interconnect path to be aware of the defect, repair, and associated logical shifting operation, such as by having a master device scan interconnect paths for connectivity failures and then program an associated slave device with an address of any failed path.

Various illustrative embodiments of the present invention will now be described detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are depicted with reference to simplified cross sectional and block diagram depictions without including every device feature or geometry in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

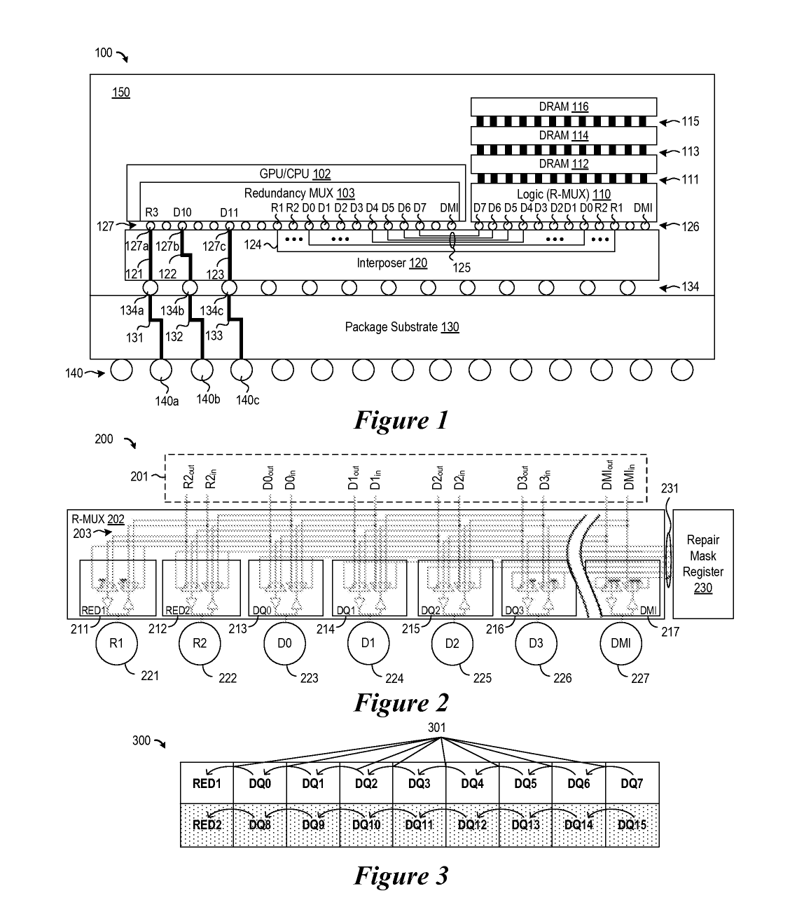

Turning now to FIG. 1, there is depicted a cross-sectional view of an example integrated circuit device 100 with a processor unit 102 and a stacked memory 110-116 connected across an electrical interface routing 120 of conductor lines 124-125 and microbump conductors 126-127. As depicted, the integrated circuit device 100 includes multiple dies 102, 110, 112, 114, 116 that are mounted, assembled, attached or stacked together on one or more substrates prior to packaging in package 150. To enable signal information to be exchanged by the die, electrical connectors are provided to define data and control channels between the die. The electrical connectors may be formed with microbump conductors 111, 113, 115, 126-27, bump conductors 134, and solder ball conductors 140, and may also include wire conductors for connecting contact pads on different dice. As but one example, over 4000 data channel conductors and 2000 miscellaneous control conductors may be included in a single multi-die integrated circuit device.

One of the die may be a microprocessor die 102, such as a graphics processing unit (GPU) or central processing unit (CPU). As described more fully below, the processor die 102 may include a memory controller module having a redundancy multiplexer circuit 103 along with input/output interface test circuitry that may be used to detect and repair I/O interconnect channel failures using one or more replacement I/O interconnect channels. The processor die 102 also includes I/O external terminals formed on a first face (not shown) and positioned for connection to microbump connectors 127 or other I/O conductor elements for purposes of defining interconnect channels over which data and other control signal information is conveyed. After determining that the processor die 102 passes a wafer or die test, the die 102 may be mounted onto an interposer substrate 120 using the microbump connectors 127.

In addition or in the alternative, the integrated circuit device 100 may include another die, such as a stacked semiconductor device. The stacked semiconductor device may be implemented as a stacked device which includes a logic interface chip 110 and one or more memory die 112, 114, 116. In selected embodiments, the stacked semiconductor device includes two stacks of up to sixteen DRAM dice. Each memory die (e.g., 112) has one or more arrays of memory cells (e.g., DRAM cell arrays) and circuitry for storing and retrieving data at the memory cells, such as sense amplifier circuits, address decoders, and other control circuits. Each memory die also includes external terminal contacts formed on the top and/or bottom surfaces and positioned to make electrical contact with the logic interface chip 110 or other memory die via patterned metal layers 111, 113, 115. Further, each of the memory die 112, 114, 116 may have signal conductor lines extending between the external terminal contacts on the top and bottom surfaces. As depicted, the logic interface chip 110 includes a redundancy multiplexer circuit (R-MUX) and other input/output interface test circuitry that is used to detect and repair I/O interconnect channel failures using one or more replacement I/O interconnect channels. After determining that the logic interface chip 110 and memory dice 112, 114, 116 pass a wafer or die test, the individual die are sequentially mounted onto the interposer substrate 12.0 using microbump connectors 126 and patterned metal or die-to-die vias layers 111, 113, 115.

The interposer 120 provides electrical interface routing between the die by spreading electrical connections to a wider pitch. Though not explicitly shown, the interposer 120 has a first plurality of external terminals formed on a first face for making electrical contact with the processor die 102 via microbump connectors 127, and also includes a plurality of metal interconnect lines 124-125 formed with through-silicon via and conductor lines and electrically connected to a second plurality of external terminals formed on the first face of the interposer 120 and positioned to make electrical contact with the stacked semiconductor device 110-116 via microbump connectors 126. The interposer 120 may also include additional external terminals formed on the first face (not shown) and connected to one or more through-silicon via and conductor lines 121-123 formed in the interposer 120 for purposes of connecting the processor die 102 to an external circuit or signal line using one or more data channels. For example a first data channel for the processor 102 is formed over an I/O interconnect which includes the interposer TSV 121 and package substrate TSV 131 which are connected to selected microbump conductor 127a, bump conductor 134a, and solder ball conductor elements 140a. Likewise, a second data channel is formed over an I/O interconnect which includes the interposer TSV 122 and package substrate TSV 132 which are connected via microbump conductor 127b, bump conductor 134b, and solder ball conductor elements 140b, while a third data channel is formed over an I/O interconnect which includes the interposer TSV 123 and package substrate TSV 133 which are connected via microbump conductor 127c, bump conductor 134c, and solder ball conductor elements 140c.

By mounting a microprocessor die (e.g., a graphics processing unit (GPU) or central processing unit (CPU) with a stacked memory die 110-116 on an interposer 120, low latency signals may be exchanged across I/O interconnect channels formed from routing lines 124-125 in the interposer 120. In addition or in the alternative, the processor die 102 may exchange signals with one or more die in a separate package (not shown) using I/O interconnect channels formed from I/O through-silicon via conductors 121-123, 131-133, bump conductors 134, and solder ball conductors 140. Whether forming internal or external interconnect channels, the integration and stacking process used to assemble the packaged integrated circuit device 100 will result in an increased probability of connection failure as the electrical connection count increases. The connection failures can be caused by faults of through electrodes extending through a die, contact electrodes (e.g., microbumps) connecting or shorting together, and/or interconnect conductors (e.g., microbumps) failing to make electrical connection as intended. Any single interconnect failure in a multi-die assembly can result in an expensive loss of known-good silicon, thereby reducing yield.

To prevent yield losses from interconnect failures, the integrated circuit device 100 may be provided with extra I/O interconnect channels and associated switching circuitry which are used to recover from interconnect channel failures. In the example of FIG. 1, the extra or replacement I/O interconnect channels may include one or more redundant channels (e.g., R1, R2) for internal signaling with the stacked memory 110-116. In addition or in the alternative, one or more redundant channels (e.g., R3) may be included for external signaling. In operation, the processor die 102 ordinarily uses regular or mission-mode 110 interconnect channels D0-D7 to exchange signal information with the stacked memory 110-116 over routing lines 125. With conventional systems, the bus interface between die would have only as many channels as needed for a given bandwidth, and any defect (e.g., short or open circuit) on a channel would cause the part to fail. As disclosed herein, these failures can be prevented or repaired by switching one of the extra I/O interconnect channels (e.g., R1) to replace a defective channel (e.g., D0). Under control of a redundancy multiplexer circuitry at the processor die and stacked memory, a defective mission-mode I/O interconnect channel is replaced with one of the extra I/O interconnect channels (e.g., R1) so that the processor die 102 can exchange signal information over the routing interconnect lines (e.g., 124) with the stacked memory 110-116. In this way, the multiplexer circuits at each die work in concert to replace a failed mission-mode I/O interconnect channel by reassigning or shifting the data channels to avoid the failed channel, thereby steering data to a repair interconnect channel. To prevent signal latency, the extra I/O interconnect channels (e.g., R1, R2) may be formed to replicate the mission-mode interconnect channels, such as by using corresponding conductor elements (e.g., microbump conductors 126-27 and signal lines 124) formed in close proximity with the same processing steps.

The integrated circuit device 100 may also include extra I/O interconnect channels for repairing defective external I/O interconnect channels to external circuits. For example, an open or short circuit in an external I/O interconnect channel (e.g., D10) could be repaired by using an extra I/O connection channels (e.g., R3) as a replacement channel. To make the repair, the redundancy multiplexer 103 at the processor die 102, reassigns or shifts the failed channel 1310 to the replacement channel R3. Thus, instead of using the failed interconnect path (127b, 122, 134b, 132, 140b), the processor 102 switches to exchange signal information over the I/O interconnect defined by microbump 127a, interposer TSV 121, bump 134a, package substrate TSV 131, and solder bump conductor 140a. As will be appreciated, a corresponding reassignment or shift will be made at the external circuitry.

As will be appreciated, the interconnect channel repair scheme may be implemented in any integrated circuit device having a plurality of signal interconnections to or from individual die, including but not limited to stacked semiconductor devices with multiple signal interconnects where a defective signal interconnect path can be replaced with a replacement signal interconnect path. In general terms, the integrated circuit device includes a parallel arrangement of one or more replacement signal paths and a multiplexer circuit which bypasses a defective signal path and shifts the signals to include one or more of the replacement signal paths. The multiplexer circuit may implement any desired fixed or programmable switching function to steer data away from the failed signal path and to the replacement signal path.

To control the path switching operations which provide path redundancy, the integrated circuit device a redundancy control mechanism for detecting and repairing broken communication channels. Any desired connection test mechanism can be used to detect failed or defective I/O interconnect paths, including but not limited to software and/or hardware features for performing link tests between devices. By way of example and not limitation, low speed boundary scan tests can be performed to detect short circuit and open circuit defects. Other types of path defects can be detected, such as by performing loopback tests to discover path defects that result in frequency loss over the paths.

The redundancy control mechanism should also allow both d s of the broken communication channel (e.g., processor die 102 and stacked semiconductor die (110-116) to be aware of the defect, repair, and associated logical shifting operation. The coordinated redundancy control may be implemented by having a master device (e.g., processor 102) that scans the channels (e.g., DQ0-DQ7 and DMI) for connectivity failures and then programs the master device and associated slave device (e.g., stacked semiconductor die 110-116) accordingly. The address of the failed interconnect 10 path can be programmed in each device (e.g., in a repair mask register 230) so that each device can shifts the data as agreed to in the redundancy scheme. In various embodiments, the repair address can be a set of fuses or registers, and can be set as permanent repair or a temporary repair. An advantage of providing a temporary repair is to allow for changes in path failure status so that repairs can be changed accordingly. An example of a change in path failure status is where a failure changes as temperatures change in the system, or as the system ages, due to thermal stress and corrosion. By enabling the redundancy control mechanism to periodically detect the presence of channel connectivity failures as temperatures change over time, and/or at system boot, the path failures can be dynamically repaired over time.

To illustrate an example multiplex switching function, reference is now made to FIG. 2 which depicts a redundancy multiplexer switching system 200 for switching or routing data channels to interconnect paths and replacement interconnect paths in accordance with selected embodiments. As depicted, the depicted switching system 200 connects output data channels 201 (e.g., D0-D3) over a redundancy multiplexer circuit 202 to designated output interconnect paths 222-225 and replacement output interconnect paths 221 under control of one or more selection signals 231 so that any failed or defective output interconnect path can be avoided. However, it will be appreciated that input data channels can be similarly routed from the interconnect paths 221-225 using similar multiplexing circuitry to avoid failed or defective interconnect paths. To selectively route output data channels 201, the multiplexer circuit 202 includes an output channel multiplex circuit (e.g., 211-215) for each interconnect path 221-225, each of which is connected to one or more data channels which may be selected for output by one of the selection control signals 231.The selection control signals 231 may be stored at a repair mask register 230 or otherwise generated so that each individual selection signal has a sufficient bit width to uniquely select each output from the input and output multiplexers at each output channel multiplex circuit. With the depicted output channel multiplex circuits (e.g., 212), a single bit is sufficient to uniquely select one of the two connected data channel inputs presented at inputs “0” and “1.” However, it will be appreciated that control of redundancy multiplexer circuit 202 could be optimized such that only three bits are used for selection signals 231 instead of the five shown by having the output channel multiplex circuits 211 and 215 be replace with fixed values (namely, D3 and D0, respectively).

To connect the output data channels (e. D0-D3) to their corresponding output interconnect paths, each output channel multiplex circuit (e.g., 212) may include an output multiplexer and amplifier connected to receive a plurality of output data channel signals (e.g., D3 and D2) that are connected across signal conductors 203. Under control of a selection signal 231, the output channel multiplex circuit selects and outputs one of the received output data channel signals to the associated output interconnect path conductor (e.g., 222)). By forming the signal conductors 203 to simultaneously connect each output data channel signal (e.g., D2) to one or more adjacent input/output channel multiplex circuits (e.g., 212-213), the output data channel signal can be connected to any of the connected output interconnect path conductors (e.g., 222.223) based on the applied selection signals 231.

As illustrated in FIG. 2(a), if the output interconnect path conductors 222-225 associated with mission-mode output channels D3-D0 are not defective, then the selection signals 231 would be applied to select signal “0” in each of the output channel multiplex circuits 211-215. As a result, each of the output channel multiplex circuits 212-215 outputs the data channel at input “0” to its corresponding interconnect path 222-225. On the other hand and as illustrated in FIG. 2(b), if one of the output interconnect path conductors (e.g., path 223 associated with mission-mode output channel D2) is defective, then the selection signals 232 would be applied to effectively disable the defective output interconnect path conductor and to select a spare or replacement output interconnect path (e.g., 221) to assist with conveying the output data channels. In order to shift around the failed path, the selection signals 232 would be applied to select signal “0” in each of the output channel multiplex circuits 213-215 and to select signal “1” in each of the output channel multiplex circuits 211-212. The result is that data channels D1-D0 are connected, respectively, across output channel multiplex circuits 214-215 to interconnect paths 224-225, and data channels D3-D2 are connected, respectively, across output channel multiplex circuits 211-212 to interconnect paths 221-222. And while the “0” selection control signal applied to output channel multiplex circuit 213 also connects the data channel D2 to failed interconnect path 223, this is not a problem since the same data channel is also connected across output channel multiplex circuit 212 to interconnect path 222.

As will be appreciated, additional multiplex circuit configurations can be used to selectively connect each output data channel to additional interconnect paths. For example, each output channel multiplex circuit may be configured as a three-to-one multiplex functionality which is controlled by selection signals to select from three adjacent output data channels for output to an associated interconnect path. In this way, an output data channel can be shifted from a mission-mode or default interconnect path to either of two adjacent interconnect paths, depending on the connection state of each path. In addition or in the alternative, the redundancy multiplexer circuit 202 may include input channel multiplex circuits for switching the interconnect paths to a designated input data channel under control of one or more input selection signals. To this end, a defective interconnect path is not used, and the input data channels are instead conveyed over the spare interconnect path 221 and the non-defective interconnect paths using the input channel multiplex circuits to switch the input data channels to the appropriate data channels 201.

Turning now to FIG. 3, there is shown a channel mapping example wherein mission-mode data channels may be allocated as data channel groups to a replacement I/O interconnect path to define a repair channel group. In the depicted channel allocation 300, a first group of data channels (D0-D7) is assigned to a first replacement I/O interconnect path RED1, and a second group of data channels (D8-D15) is assigned to a second replacement I/O interconnect path RED2. Within each repair channel group, each of the mission-mode data channels are ordinarily connected to a corresponding default I/O interconnect path by the multiplexer circuit. But upon detection of any defect or failure in one of the default I/O interconnect paths, the multiplexer effectively repairs the defective I/O interconnect path by shifting the data away from the failed path to an adjacent neighbor, starting at the failed path, as indicated by the shift arrows 301. Thus, a failure in the I/O interconnect path for channel DQ0 is repaired by shifting the DQ0 data to the RED1 I/O interconnect path while the remaining channel assignments for DQ1-DQ7 are unchanged. Similarly, a failure in the I/O interconnect path for channel DQ3 is repaired by shifting each of the DQ0, DQ1, DQ2, and DQ3 data channels to the left one channel position to use the RED1. I/O interconnect path while the remaining channel assignments for DQ4-DQ7 are unchanged. Defects in default I/O interconnect paths from other repair channel groups (e.g., RED2, DQ8-DQ15) may be independently repaired under control of the multiplexer by shifting data away from any failed path to an adjacent neighbor, starting at the failed path, as indicated by the shift arrows.

As will be appreciated, any number of replacement I/O interconnect paths may be used with each repair channel group. In addition, the physical and logical placement of the repair channel groups can affect the available failure coverage. For example, FIG. 3 illustrates a non-interleaved allocation of repair channel groups 300 wherein each group of data channels (e.g., D0-D7) and assigned replacement I/O interconnect path (e.g., RED1) are physically contiguous with one another. The non-interleaved allocation of repair channel groups 300 allows the repair of vertical short-circuit faults between data channels (e.g., between DQ2 and DQ10) since each repair channel group could be shifted one position to use its corresponding assigned replacement I/O interconnect path. However, the non-interleaved channel groups 300 could not be used to repair horizontal shorts (e.g., between DQ2 and DQ3) because there are not enough replacement I/O interconnect paths to repair two failed channels in the same horizontal group.

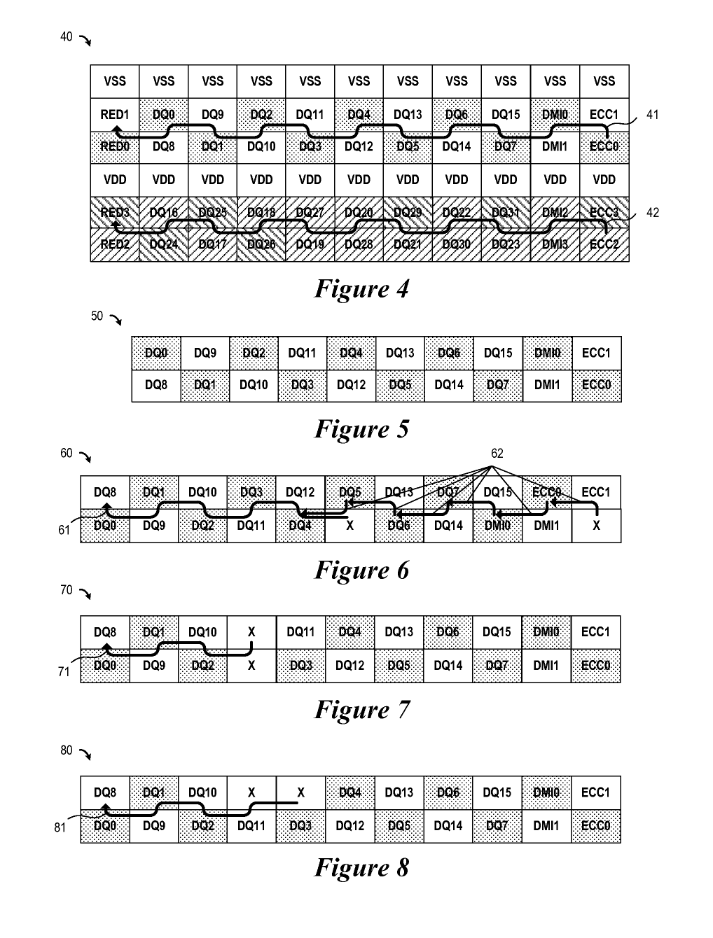

To improve failure coverage, data channels may be allocated into repair channel groups that are physically interleaved with one another. To provide an example illustration, reference is now made to FIG. 4 which shows an interleaved allocation 40 of four different groups of data channels and replacement channels in accordance with selected embodiments of the present invention. The data channels and replacement channels are shown as an array of I/O interconnects (DQ0-DQ31, RED0-RED3) and reference voltage interconnects (V_{SS}, V_{DD}) that are arranged in interleaved repair channel groups. A first repair channel group includes a first group of data channels (D0-D7), an assigned replacement I/O interconnect path (RED0), a DMI interconnect path (DMI0), and a first ECC interconnect path (ECC0). A second repair channel group includes a second group of data channels (D8-D15), an assigned replacement I/O interconnect path (RED1), a DMI interconnect path (DMI1), and a second ECC interconnect path (ECC1). The first repair channel group is physically interleaved with a second repair channel group under control of the multiplexer circuit which effectively repairs a defective I/O interconnect path by shifting the data away from the failed path. The third repair channel group (RED2, DQ16-DQ23, DMI2, ECC2) and fourth repair channel group (RED3, DQ24-DQ31, DMI3, ECC3) are also physically interleaved with one another under control of the multiplexer. With interleaved repair channel groups, the multiplexer implements an interleaved shift path 41, 42 to shift the data away from the failed path to an immediately adjacent neighbor, starting at the failed path.

If there are no defects or failures (e.g., open or short circuits) in any of the interleaved repair channel groups, then the multiplexer assigns each mission-mode data channel to its default I/O interconnect path, and no path shifting is required. To illustrate the default channel assignment, reference is made to FIG. 5 which illustrates the allocation 50 of the first and second repair channel groups from FIG. 4 in the case when there are no failed data channels. In this case, the replacement I/O interconnect paths RED0, RED1 are not used.

In the event that a defect or failure is detected in any I/O interconnect path in the interleaved repair channel groups, the defect in that repair channel group can be repaired by shifting data from the failed I/O interconnect path DQ12 to the next adjacent I/O interconnect path in the repair channel group. To this end, the multiplexer repairs a failure in the I/O interconnect path for channel DQ12 by shifting the DQ12, data to the default DQ11 I/O interconnect path, with a corresponding shift of the DQ11, DQ10, DQ9, and DQ8 channel data to the default DQ10, DQ9, DQ8, and RED1 I/O interconnect paths, respectively. With only the failed I/O interconnect path DQ12 being repaired, the remaining channel assignments for DQ0-DQ7 and DQ13-DQ15 would not be changed, and only the replacement I/O interconnect path associated with the defective repair channel group (RED1) is used.

The interleaved repair channel groups also enable repair of two non-adjacent I/O interconnect paths from two different repair channel groups. To illustrate this example, reference is now made to FIG. 6 which shows the allocation 60 of two groups of data channels from FIG. 4 after the data channels are shifted away from two non-adjacent failed data channels (D12 and ECC0) to use the replacement channels in accordance with selected embodiments of the present invention. To repair the failure in the I/O interconnect path for channel DQ12, the multiplexer implements an interleaved shift path 61 to shift the DQ12 data to the default DQ11 I/O interconnect path, with a corresponding shift of the DQ11, DQ10, DQ9, and DQ8 channel data to the default DQ10, DQ9, DQ8, and RED1 I/O interconnect paths, respectively. In addition, the multiplexer repairs the failure in the I/O interconnect path for channel ECC0 by implementing an interleaved shift path 62 to shift the ECC0 data to the default DMI0 I/O interconnect path, with a corresponding shift of the DMI0, and DQ7-DQ0 channel data to the default DQ7-DQ0, and RED0 I/O interconnect paths, respectively. In this example, the DQ0-DQ12, DMI0, ECC0 data channels are shifted, the default I/O interconnect paths for data channels DQ12, ECC0 are bypassed, and the remaining default channel assignments for data channels DQ13-DQ15, DMI1, and ECC1 would not be changed.

Failures in vertically adjacent failed I/O interconnect paths (e.g., a vertical short) from two different repair channel groups can also be repaired with the interleaved repair channel groups. To illustrate this example, reference is now made to FIG. 7 which shows the allocation 70 of two groups of data channels from FIG. 4 after the data channels are shifted away from two vertically-adjacent failed data channels (D2 and DQ10) to use the replacement channels (RED0, RED1) in accordance with selected embodiments of the present invention. To repair the failure in the I/O interconnect path for channel DQ2, the multiplexer implements an interleaved shift path 71 to shift the DQ2 data to the default DQ1 I/O interconnect path, with a corresponding shift of the DQ1 and DQ0 channel data to the default DQ0 and RED0 I/O interconnect paths, respectively. In addition, the multiplexer repairs the failure in the 110 interconnect path for channel DQ10 by implementing the interleaved shift path 71 to shift the DQ10 data to the default DQ9 110 interconnect path, with a corresponding shift of the DQ9 and DQ8 channel data to the DQ8 and RED1 110 interconnect paths, respectively. In this example, the DQ0-DQ2 and DQ8-DQ10 data channels are shifted, the default I/O interconnect paths for data channels DQ2 and DQ10 are bypassed, and the remaining channel assignments for DQ3-DQ7, DQ11-DQ15, DMI0-1, and ECC0-1 would not be changed.

With interleaved repair channel groups, failures in horizontally adjacent I/O interconnect paths from two different repair channel groups (e.g., a horizontal short) can also be repaired. To illustrate this example, reference is now made to FIG. 8 which shows the allocation 80 of two groups of data channels from FIG. 4 after the data channels are shifted away from two horizontally-adjacent failed data channels (D2 and DQ11) to use the replacement channels RED0, RED1. To repair the failure in the I/O interconnect path for channel DQ12, the multiplexer implements an interleaved shift path 81 to shift the DQ2 data to the default DQ1 I/O interconnect path, with a corresponding shift of the DQ1 and DQ0 channel data to the default DQ0 and RED0 I/O interconnect paths, respectively. In addition, the multiplexer repairs the failure in the I/O interconnect path for channel DQ11 by implementing the interleaved shift path 81 to shift the DQ11 data to the default DQ10 I/O interconnect path, with a corresponding shift of the DQ10-DQ8 channel data to the DQ9-RED1 I/O interconnect paths, respectively. In this example, the DQ0-DQ2 and DQ8-DQ11 data channels are shifted, the default I/O interconnect paths for data channels DQ2 and DQ11 are bypassed, and the remaining channel assignments for DQ3-DQ7, DQ12-DQ15, DMI0-1, and ECC0-1 would not be changed.

As seen from the foregoing, the interleaved allocation of repair channel groups can use two replacement I/O interconnect paths RED1, RED2 to repair an open circuit defect in each of the repair channel groups, and can also be used to repair a horizontal or vertical short circuit between two I/O interconnect paths. The repair feature uses extra I/O interconnect paths in interleaved repair channel groups to protect against both vertical and horizontal shorts between the repair channel groups, and can also protect against an open circuit failure in each repair channel group. It will be appreciated that the path switching function used with the interleaved repair channel groups illustrated in FIGS. 4-8 can be implemented with a 2-1 multiplexer circuit, since each data channel is connected to only two I/O interconnect paths. As a result, the multiplexer control signal requires only 16 bits per data word (e.g., DQ0-DQ7) to encode the multiplexer circuit. Of course, additional repair capabilities can be obtained by including additional replacement I/O interconnect paths, but at the expense of more complex multiplexer circuit design and control signal requirements.

Due to cost or space constraints, it may not always be feasible to add extra replacement I/O interconnect paths to a design as described hereinabove. In such cases, the path repair benefits may still be obtained by re-purposing one or more I/O interconnect paths to provide the repair function. For example, one or more ECC I/O interconnect paths associated with a group of data channels may be re-purposed as a replacement I/O interconnect path in the event of a failure of one of the default I/O interconnect paths associated with a data channel. While the resulting repaired data channel group will not support ECC operations, this is a relatively small price to pay for benefit of repairing a data channel group that would otherwise not be functional.

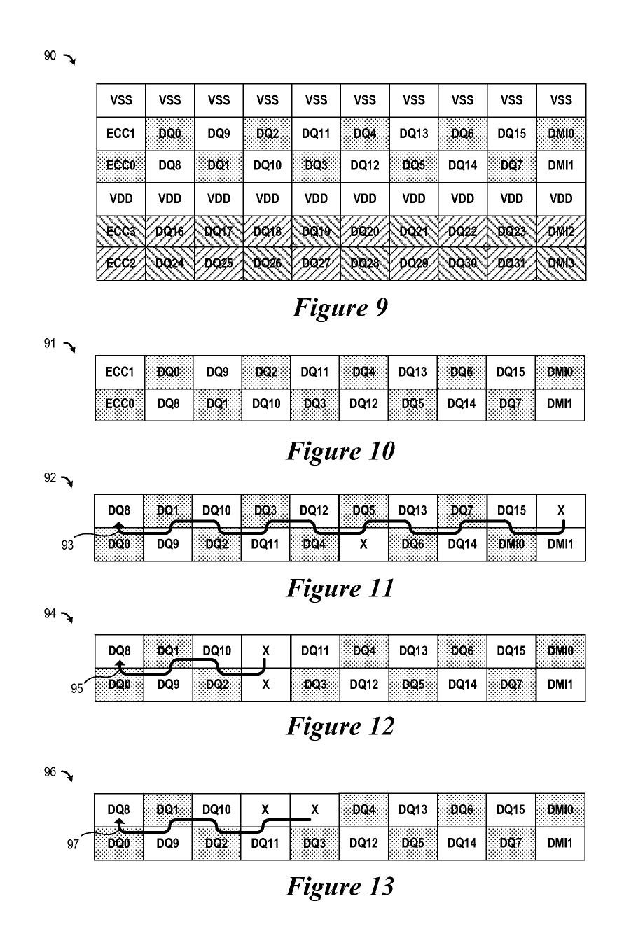

To illustrate how selected I/O interconnect paths can be repurposed as replacement paths to improve failure coverage, reference is now made to FIGS. 9-13 which illustrate how data channels may be allocated into repair channel groups that are physically interleaved with one another. Starting with FIG. 9, there is illustrated an interleaved allocation 90 of four different groups of data channels (DQ0-DQ7, DQ8-DQ15, DQ16-DQ23, and DQ24-DQ31) and associated ECC channels (ECC0-4) arranged in any array of I/O interconnects (DQ0-DQ31, ECC0-3) and reference voltage interconnects (V_{SS}, V_{DD}), but there are no extra interconnect I/O paths provided. A first channel group includes an first ECC I/O interconnect path (ECC0), a first group of data channels (D0-D7), and a DMI interconnect path (DMI0), while a second channel group includes a second ECC interconnect path (ECC1), a second group of data channels (D8-D15), and a DMI interconnect path (DMI1). The first channel group is physically interleaved with a second channel group under control of the multiplexer circuit. In similar fashion, a third channel group (EEC2, DQ16-DQ23, DMI2) and fourth repair channel group (ECC3, DQ24-DQ3 DMI3) are also physically interleaved with one another under control of the multiplexer.

If there are no defects or failures (e.g., open or short circuits) in any of the interleaved channel groups, then the multiplexer assigns each mission-mode data channel to its default I/O interconnect path, and no path shifting is required. FIG. 10 illustrates the default channel assignment allocation 91 of the first and second channel groups from FIG. 9 in the case when there are no failed data channels. In this allocation, the ECC data channels ECC0, ECC1 can be used if needed.

In the event that a defect or failure is detected in any I/O interconnect path in the interleaved channel groups (e.g., DQ0-DQ7 or DQ8-DQ15), the defect(s) in the channel group(s) can be repaired by forming a repair channel group using the ECC I/O interconnect path as a replacement I/O interconnect path, and then shifting data from the failed I/O interconnect path to the next adjacent I/O interconnect path in the repair channel group. In this way, interleaved repair channel groups can be formed and used to repair defective I/O interconnect paths from two different repair channel groups. To illustrate this example, reference is now made to FIG. 11 which shows the allocation 92 of two groups of data channels from FIG. 9 after ECC channel paths (ECC0, ECC1) are re-purposed as replacement channel paths so that the data channels can be shifted away from failed data channels (D12 and DMI0) to use the replacement channel paths. To repair the failure in the I/O interconnect path for channel DQ12, the multiplexer implements an interleaved shift path 93 to shift the DQ12 data to the default DQ11 I/O interconnect path, with a corresponding shift of the DQ11, DQ10, DQ9, and DQ8 channel data to the default DQ10, DQ9, DQ8, and ECC1 I/O interconnect paths, respectively (where the ECC1 I/O interconnect path has been repurposed as a replacement I/O interconnect path). In addition, the multiplexer repairs the failure in the I/O interconnect path for DMI0 channel using the interleaved shift path 93 to shift the DMI0 data to the default DQ7 I/O interconnect path, with a corresponding shift of the DQ7-DQ0 channel data to the default DQ6-DQ0, and ECC0 I/O interconnect paths, respectively (where the ECC0 I/O interconnect path has been repurposed as a replacement I/O interconnect path). In this example, the DQ0-DQ12 and DMI0 data channels are shifted, the default I/O interconnect paths for data channels DQ12, DMI0 are bypassed, and the remaining default channel assignments for data channels DQ13-DQ15 and DMI1 would not be changed. In this allocation, the ECC data channels ECC0, ECC1 are not available for use.

The repurposed ECC I/O interconnect paths can also be used to repair failures vertically-adjacent I/O interconnect paths (e.g., a vertical short) from two different data channel groups. This is illustrated in FIG. 12 which shows the allocation 94 of two groups of data channels from FIG. 9 after ECC channel paths (ECC0, ECC1) are re-purposed as replacement channel paths to permit data channels to be shifted away from two vertically-adjacent failed data channels (D2 and DQ10) using the replacement channel paths. To repair the failure in the I/O interconnect path for channel DQ2, the multiplexer implements an interleaved shift path 95 to shift the DQ2 data to the default DQ1 I/O interconnect path, with a corresponding shift of the DQ1 and DQ0 channel data to the default DQ0 and ECC0 I/O interconnect paths, respectively (where the ECC0 I/O interconnect path has been repurposed as a replacement I/O interconnect path). In addition, the multiplexer repairs the failure in the I/O interconnect path for channel DQ10 by implementing the interleaved shift path 95 to shift the DQ10 data to the default DQ9 I/O interconnect path, with a corresponding shift of the DQ9 and DQ8 channel data to the DQ8 and ECC1 I/O interconnect paths, respectively (where the ECC0 I/O interconnect path has been repurposed as a replacement I/O interconnect path). In this example, the DQ0-DQ2 and DQ8-DQ10 data channels are shifted, the default I/O interconnect paths for data channels DQ2 and DQ10 are bypassed, and the remaining channel assignments for DQ3-DQ7, DQ11-DQ15, and DMI0-1 would not be changed. In this allocation, the ECC data channels ECC0, ECC1 are not available for use.

In addition, the repurposed ECC I/O interconnect paths can be used to repair failures in horizontally-adjacent I/O interconnect paths (e.g., a horizontal short) from two different data channel groups. This is illustrated in FIG. 13 which shows the allocation 96 of two groups of data channels from FIG. 9 after ECC channel paths (ECC0, ECC1) are re-purposed as replacement channel paths to permit data channels to be shifted away from two horizontally-adjacent failed data channels (D2 and DQ11) to use the replacement channels. To repair the failure in the I/O interconnect path for channel DQ2, the multiplexer implements an interleaved shift path 97 to shift the DQ2 data to the default DQ1 I/O interconnect path, with a corresponding shift of the DQ1 and DQ0 channel data to the default DQ0 and ECC0 I/O interconnect paths, respectively (where the ECC0 I/O interconnect path has been repurposed as a replacement I/O interconnect pa(h). In addition, the multiplexer repairs the failure in the I/O interconnect path for channel DQ11 by implementing the interleaved shift path 97 to shift the DQ11 data to the default DQ10 I/O interconnect path, with a corresponding shift of the DQ10-DQ8 channel data to the DQ9-ECC1 I/O interconnect paths, respectively (where the ECC1 I/O interconnect path has been repurposed as a replacement I/O interconnect path). In this example, the DQ0-DQ2 and DQ8-DQ11 data channels are shifted, the default I/O interconnect paths for data channels DQ2 and DQ11 are bypassed, and the remaining channel assignments for DQ3-DQ7, DQ12-DQ15, and DMI0-1 would not be changed. In this allocation, the ECC data channels ECC0, ECC1 are not available for use.

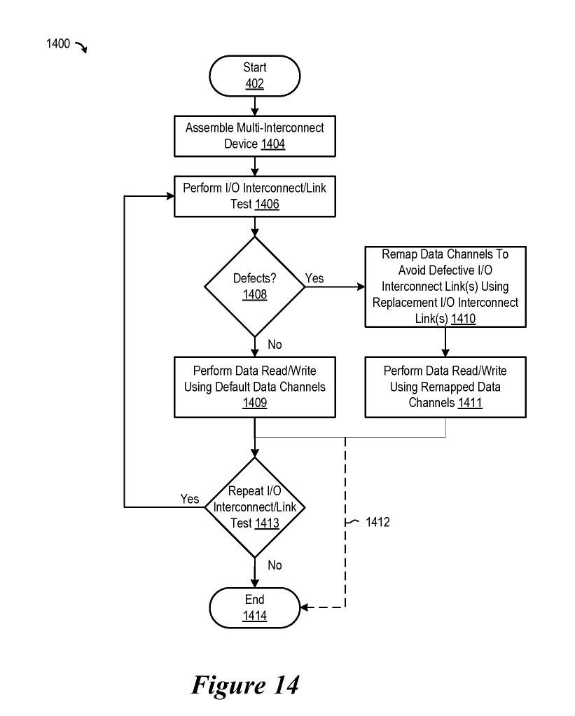

Turning now to FIG. 14, an exemplary method 1400 is illustrated for providing interconnect redundancy. After the method begins at step 1402, a multi-interconnect device is assembled or provided (step 1404). In an example embodiment, the multi-interconnect device may be an integrated circuit device having multiple interconnect links, including but not limited to a system on a chip (SoC) or a system in package (SiP) having a stacked DRAM and controller circuitry on one or more integrated circuit die.

At step 1406, the interconnect links are tested to detect any defect or failures. Any desired link test can be performed, such as using boundary scan test procedures to detect short circuit and open circuit failures. In addition or in the alternative, at-speed tests can be performed to detect functional defects in the interconnect links, such as defects resulting in frequency loss of data.

If the link test indicates that there are no failed or defective interconnect links (negative outcome to decision step 1408), then the multi-interconnect device uses the default data channel assignments to perform data operations at step 1409. In an example scenario, the default chain order for a first data channel group would include interconnect links RED (unused), DQ8, DQ7, DQ6, DQ5, DQ4, DQ3, DQ2, DQ1, DQ0, DMI, ECC0. A multiplexer circuit controlled by one or more selection control signals may be used to assign the default interconnect links to the mission-mode data channels for performing read and write operations. If there are no link defects, the multiplexer does not assign the RED link to a data channel.

However, if the link test indicates that there are one or more failed or defective interconnect links (affirmative outcome to decision step 1408), then the data channels for the multi-interconnect device are remapped to bypass the defective interconnect link(s) at step 1410, and the data operations are performed using remapped data channels at step 1411. In an example scenario where a defect is detected at default DQ6 link, the chain order for the first data channel group is remapped to RED (now DQ8), DQ8 (now DQ7), DQ7 (now DQ6), DQ6 (unused), DQ5, DQ4, DQ3, DQ2, DQ1, DQ0, DMI, and ECC0. The remapping may be implemented by applying the selection control signal(s) to the multiplexer circuit so that the data read and write operations are performed using the remapped data channels. In this way, the multiplexer is configured to implement a predetermined shift rule whereby any failed interconnect link is bypassed and not used, and all data channels up to the failed interconnect link are shifted “leftward” towards a replacement interconnect link. As described herein, the replacement interconnect link may be an extra or repurposed interconnect link.

In embodiments where the data channel remapping is performed once (e.g., at during manufacture test), the method ends (step 1414), as indicated by the dashed line 1412. However, the data channel remapping may also be iterated over time to dynamically update and adjust the channel mapping based on changing interconnect link conditions. In this case, a decision is periodically made at step 1413 to determine if another interconnect link test should be performed. This decision my be implemented by running a timer which determines when the next interconnect link test is performed. Upon detecting that another interconnect link test is to be performed (affirmative outcome to decision 1413), the method loops back perform the link test (step 1406). Otherwise, the method ends (step 1414).

By now it will be appreciated that there is disclosed herein a method and apparatus for conveying one or more data channel groups to or from a first multi-interconnect device. In the disclosed multi-interconnect device, data channels are conveyed using at least one spare interconnect path and a plurality of default interconnect paths initially allocated to each data channel group in a default allocation. In selected embodiments, spare interconnect path(s) may include a dedicated spare interconnect path or an interconnect path for a feature, such as an error correction code (ECC) feature, that can be programmatically disabled. Upon detecting a failed interconnect path in the plurality of default interconnect paths, the functional interconnect paths are identified, a data channel group is routed to or from the first multi-interconnect device using the plurality of functional interconnect paths and the spare interconnect path. The detection step may be performed once, or repeatedly at predetermined intervals to dynamically identify functional interconnect paths over time. In selected embodiments, the data channel group is routed by applying one or more selection control signals to a plurality of multiplexers connected, respectively, to the spare interconnect path and the plurality of default interconnect paths, where each multiplexer is connected between an interconnect path and a plurality of data channels from a data channel group and is controlled by the one or more selection control signals to route the data channel group to avoid the failed interconnect path. In other embodiments, the data channel group is routed by shifting a first initially allocated data channel away from the failed interconnect path and toward the spare interconnect path to use a first adjacent interconnect path with corresponding shifts of any affected initially allocated data channels so that the spare interconnect path is used. The data channel groups may include first and second interleaved data channel groups that arc initially allocated, respectively, to first and second rows of interconnect paths so that data channels from the first and second interleaved data channel groups alternate in each of the first and second rows of interconnect paths. In this case, the first interleaved data channel group may be routed to avoid the failed interconnect path using a predetermined shift pattern to shift a first initially allocated data channel away from the failed interconnect path and toward the first spare interconnect path. When exchanging data channel groups over the spare interconnect path and a plurality of default interconnect paths with a second multi-interconnect device, the first interconnect device may identifying the failed interconnect path to a second multi-interconnect device so that both the first and second multi-interconnect devices may be programmed to avoid the at least one failed interconnect path.

In another form, there is disclosed a stacked semiconductor device and associated method of fabrication. In the stacked semiconductor device, a memory controller circuit is connected to a stacked memory device over a plurality of fixed interconnect signal paths for conveying one or more data channel groups between the memory controller circuit and the stacked memory device. The memory controller circuit may include, for each data channel group, a plurality of multiplexer circuits connected to a spare interconnect signal path and a plurality of default interconnect signal paths initially allocated to a first data channel group. The multiplexer circuits are configurable to operate in at least a first mode (if there are no connection failures in the plurality of interconnect signal paths) and a second mode (if there is at least one connection failure in the plurality of interconnect signal paths). In this way, the multiplexer circuits, when configured in the first mode, convey the first data channel group over the plurality of default interconnect signal paths. And when configured in the second mode, the multiplexer circuits convey the first data channel group using the spare interconnect signal path to route the first data channel group to avoid a failed interconnect signal path detected in the plurality of default interconnect signal paths.

As described herein, selected aspects of the invention as disclosed above may be implemented in hardware or software. Thus, some portions of the detailed descriptions herein are consequently presented in terms of a hardware-implemented process and some portions of the detailed descriptions herein are consequently presented in terms of a software-implemented process involving symbolic representations of operations on data bits within a memory of a computing system or computing device. Generally speaking, computer hardware is the physical part of a computer, including its digital circuitry, as distinguished from the computer software that executes within the hardware. The hardware of a computer is infrequently changed, in comparison with software and hardware data., which are “soft” in the sense that they are readily created, modified or erased on the computer. These descriptions and representations are the means used by those in the art to convey most effectively the substance of their work to others skilled in the art using both hardware and software.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A multi-interconnect integrated circuit device comprising:
a first circuit for conveying a plurality of data channel groups, where the first circuit is configurable to operate in at least:
a first mode if there are no connection failures in a first plurality of default interconnect signal paths, and
a second mode if there is at least one connection failure in the first plurality of default interconnect signal paths;
where the first circuit when in the first mode is configured to convey a first data channel group over the first plurality of default interconnect signal paths, and
where the first circuit when in the second mode is configured to convey the first data channel group over a second plurality of interconnect signal paths comprising a redundant interconnect signal path for replacing a failed interconnect signal path within the first plurality of default interconnect signal paths.

2. The multi-interconnect integrated circuit device of claim 1, comprising a system on a chip (SOC), a system in package (SiP), a multichip package (MCP), a package-on-package (PoP), or a multichip module (MCM) integrated circuit device having a plurality of interconnect signal paths for conveying the first data channel group between first and second integrated circuit die.

3. The multi-interconnect integrated circuit device of claim 1, comprising a memory controller circuit connected to a stacked memory device over a plurality of interconnect signal paths for conveying the first data channel group between the memory controller circuit and the stacked memory device.

4. The multi-interconnect integrated circuit device of claim 1, where the first circuit comprises a plurality of output multiplexers which convey the first data channel group as output data over the first plurality of default interconnect signal paths in response to one or more selection control signals indicating that there are no connection failures in the first plurality of default interconnect signal paths.

5. The multi-interconnect integrated circuit device of claim 1, where the first circuit comprises a plurality of output multiplexers which convey the first data channel group as output data over the second plurality of interconnect signal paths in response to one or more selection control signals indicating that there is at least one connection failure in the first plurality of default interconnect signal paths.

6. The multi-interconnect integrated circuit device of claim 1, where the first circuit comprises a plurality of input multiplexers which convey the first data channel group as input data over the first plurality of default interconnect signal paths in response to one or more selection control signals indicating that there are no connection failures in the first plurality of default interconnect signal paths.

7. The multi-interconnect integrated circuit device of claim 1, where the first circuit comprises a plurality of input multiplexers which convey the first data channel group as input data over the second plurality of interconnect signal paths in response to one or more selection control signals indicating that there is at least one connection failure in the first plurality of default interconnect signal paths.

8. The multi-interconnect integrated circuit device of claim 1, where the redundant interconnect signal path comprises an interconnect signal path that is separate from the first plurality of default interconnect signal paths and is not connected to convey a data channel if there are no connection failures in the first plurality of default interconnect signal paths.

9. The multi-interconnect integrated circuit device of claim 1, where the redundant interconnect signal path comprises one of the first plurality of default interconnect signal paths that is repurposed as the redundant interconnect signal path if there is at least one connection failure in the first plurality of default interconnect signal paths.

10. The multi-interconnect integrated circuit device of claim 1, where each interconnect signal path in the first plurality of default interconnect signal paths and second plurality of interconnect signal paths comprises one or more patterned conductor lines, microbumps, or through-silicon via conductors for conveying a data channel signal.

11. The multi-interconnect integrated circuit device of claim 1, where the plurality of data channel groups comprises first and second interleaved data channel groups that are assigned to the interconnect signal paths in the first plurality of default interconnect signal paths and second plurality of interconnect signal paths so that channels from the first and second interleaved data channel groups alternate in a row of interconnect signal paths.

12. The multi-interconnect integrated circuit device of claim 1, further comprising test circuitry for detecting whether there is a connection failure in each of the first plurality of default interconnect signal paths.

13. A method for conveying one or more data channel groups to or from a first multi-interconnect device comprising at least one spare interconnect path and a plurality of default interconnect paths initially allocated to each data channel group in a default allocation, comprising:
detecting at least one failed interconnect path in the plurality of default interconnect paths, thereby identifying a plurality of functional interconnect paths from the plurality of default interconnect paths; and
routing a data channel group to or from the first multi-interconnect device using the plurality of functional interconnect paths and the spare interconnect path.

14. The method of claim 13, where routing the data channel group comprises applying one or more selection control signals to a plurality of multiplexers connected, respectively, to the spare interconnect path and the plurality of default interconnect paths, where each multiplexer is connected between an interconnect path and a plurality of data channels from a data channel group and is controlled by the one or more selection control signals to route the data channel group to avoid the at least one failed interconnect path.

15. The method of claim 13, further comprising identifying the at least one failed interconnect path to a second multi-interconnect device which is connected to exchange the one or more data channel groups over the spare interconnect path and a plurality of default interconnect paths so that both the first and second multi-interconnect devices are each programmed to avoid the at least one failed interconnect path.

16. The method of claim 13, where detecting at least one failed interconnect path comprises periodically detecting at least one failed interconnect path in the plurality of default interconnect paths at predetermined intervals, thereby dynamically identifying functional interconnect paths over time.

17. The method of claim 13, where routing the data channel group comprises shifting a first initially allocated data channel away from the at least one failed interconnect path and toward the spare interconnect path to use a first adjacent interconnect path with corresponding shifts of any affected initially allocated data channels so that the spare interconnect path is used.

18. The method of claim 13, where the one or more data channel groups comprise first and second interleaved data channel groups that are initially allocated respectively, to first and second rows of interconnect paths so that data channels from the first and second interleaved data channel groups alternate in each of the first and second rows of interconnect paths.

19. The method of claim 18, where routing the data channel group comprises routing the first interleaved data channel group to avoid the at least one failed interconnect path using a predetermined shift pattern to shift a first initially allocated data channel away from the at least one failed interconnect path and toward the first spare interconnect path.

20. The method of claim 13, where the at least one spare interconnect path comprises an interconnect path for a feature, such as an error correction code (FCC) feature, that can be programmatically disabled.

21. A stacked semiconductor device comprising a memory controller circuit connected to a stacked memory device over a plurality of interconnect signal paths for conveying one or more data channel groups between the memory controller circuit and the stacked memory device, where the memory controller circuit comprises a plurality of multiplexer circuits connected to a spare interconnect signal path and a plurality of default interconnect signal paths initially allocated to a first data channel group, where the plurality of multiplexer circuits is configurable to operate in at least:
a first mode if there are no connection failures in the plurality of interconnect signal paths, and
a second mode if there is at least one connection failure in the plurality of interconnect signal paths;
where the plurality of multiplexer circuits when in the first mode is configured to convey the first data channel group over the plurality of default interconnect signal paths, and
where the plurality of multiplexer circuits when in the second mode is configured to convey the first data channel group using the spare interconnect signal path to route the first data channel group to avoid a failed interconnect signal path detected in the plurality of default interconnect signal paths.
